(19) United States
(12) Patent Application Publication
(10) Pub. No.: US 2024/0238818 A1
(43) Pub. Date: Jul. 18, 2024

(54) CONTAINER

(71) Applicant: COSANGLE CO., LTD., TAIPEI CITY (TW)

(72) Inventor: JOHNNY CHU, TAIPEI CITY (TW)

(21) Appl. No.: 18/155,429

(22) Filed: Jan. 17, 2023

(51) Int. Cl. B05B 11/10; A45D 34/02

(52) U.S. Cl. CPC B05B 11/1059; A45D 34/02; A45D 2034/007

(57) ABSTRACT

A container is provided. The container mainly includes two opposite housings magnetically attached to each other and a plurality of magnetic members. A chamber for mounting a sprayer is formed between the two housings. Each of the housing consists of an inner carrier and an outer decorative cover. The magnetic members are mounted in the inner carrier and enclosed and positioned by the outer decorative cover covering the inner carrier. Thereby the two housings are connected by magnetic attraction of the magnetic members. By the inner carrier and the outer decorative cover made of different materials or having different patterns, colors or surface treatment, not only the container has diverse styles, texture and practicability of the container are also improved.

### BACKGROUND OF THE INVENTION

### Field of the Invention

The present invention relates to a container, especially to a container provided with a housing which is able to be split in halves.

### Description of Related Art

Containers are commonly used in our daily lives. For example, detergents, drinks, kitchen utensils, toiletries, cosmetics, perfume, etc. are all mounted in containers such as bottles and cans. Design of the containers is diverse. The appearance of the container can have different colors, shapes, and patterns. As to structure of the container, there are different combinations of materials, handles, seals, and nozzles. Thereby the containers are gaining favor with consumers because they are more attractive and convenient to use and having higher practicability.

Take perfumes as an example. People use different perfumes according to occasions and moods. As to a container used for mounting perfumes now, it consists of a bottle with different shapes and designs, a sprayer, and a cap. Liquids in the bottle such as cosmetics or perfumes are sprayed out by pressing the sprayer. However, the bottle has fixed shape and design and the respective products are mounted in special bottles so that the bottle can't be replaced freely. Once contents in the bottle have been used up, the bottle needs to be thrown away and this is not environmentally friendly. Thus there is room for improvement and there is a need to provide a novel container.

### SUMMARY OF THE INVENTION

Therefore, it is a primary object of the present invention to provide a container with a housing able to be split in halves and the container can be disassembled quickly and easily by magnetic attraction.

In order to achieve the above object, a container according to the present invention includes two opposite housings magnetically attached to each other and a plurality of magnetic members. A chamber for mounting a sprayer is formed between the two housings. Each of the housing consists of an inner carrier and an outer decorative cover. The magnetic members are mounted in the inner carrier and is enclosed and positioned by the outer decorative cover covering the inner carrier. Thereby the two housings are connected by magnetic attraction of the magnetic members. By the inner carrier and the outer decorative cover made of different materials or having different patterns, colors or surface treatment, not only the container has diverse styles, texture and practicability of the container are also improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view of an embodiment according to the present invention;

FIG. 2 is a perspective view of an embodiment according to the present invention;

FIG. 3 is a cross sectional view of an embodiment according to the present invention;

FIG. 4 is a cross sectional view of an embodiment along a magnetic member according to the present invention;

FIG. 5 is a cross sectional view of an embodiment along a locking member and a locking slot according to the present invention;

FIG. 6 is a schematic drawing showing a locking action of an embodiment according to the present invention;

FIG. 7 is a schematic drawing showing a releasing action of an embodiment according to the present invention;

FIG. 8 is an exploded view of another embodiment according to the present invention;

FIG. 9 is a perspective view of another embodiment according to the present invention;

FIG. 10 is a cross sectional view of another embodiment according to the present invention;

FIG. 11 is a longitudinal sectional view of another embodiment according to the present invention;

FIG. 12 is a perspective view of a further embodiment according to the present invention;

FIG. 13 is a longitudinal sectional view of a further embodiment according to the present invention.

### DETAILED DESCRIPTION OF THE PREFERRED EMBODIMENT

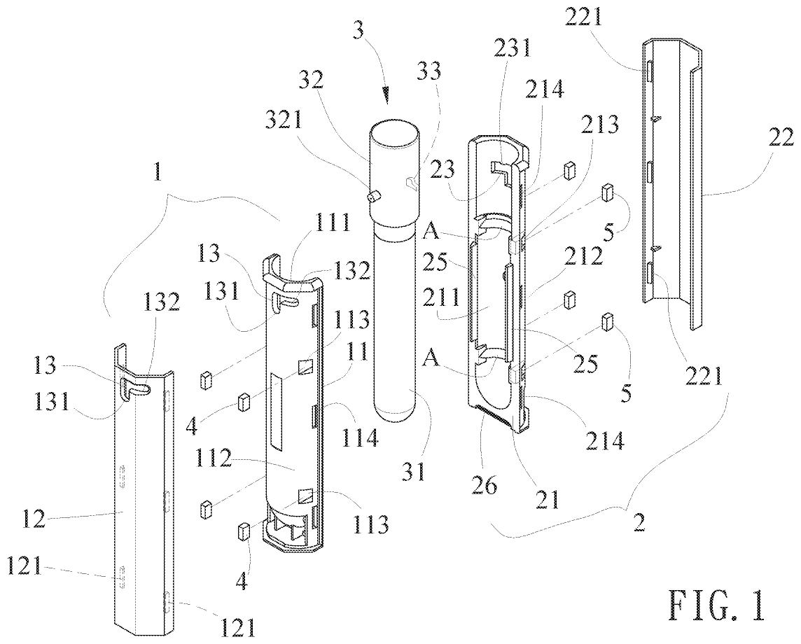

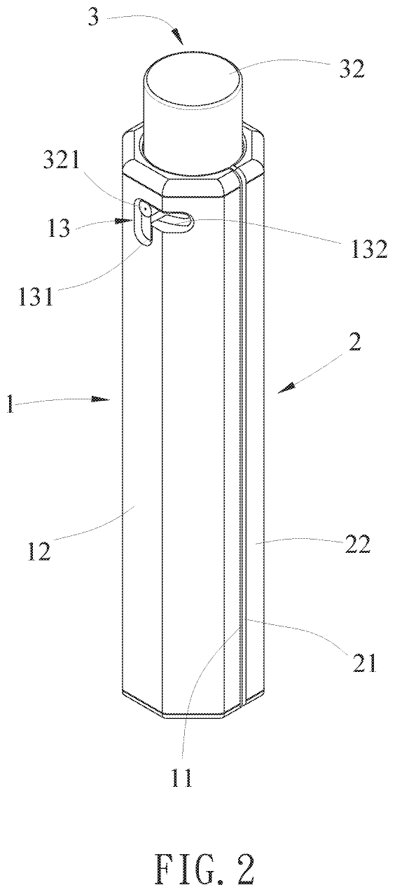

Refer to FIG. 1 and FIG. 2, a container according to the present invention mainly includes a first housing 1, a second housing 2, a sprayer 3, at least one first magnetic member 4, and at least one second magnetic member 5.

The first housing 1 consists of a first inner carrier 11 and a first outer decorative cover 12 provided with at least one first locking member 121 on an inner side of the first outer decorative cover 12. The first inner carrier 11 is composed of a first chamber 111 on an inner side thereof, a first recess 112 on an outer side thereof, and at least one first mounting slot 113 and at least one first locking slot 114 arranged at two sides of the first recess 112 correspondingly. The first mounting slot 113 is used to mount the first magnetic member 4 therein while the first locking slot 114 and the first locking member 121 corresponding to the first locking slot 114 are mounted and positioned by each other. The first outer decorative cover 12 is disposed on the first recess 112 of the first inner carrier 11 and covering the first recess 112.

The second housing 2 includes a second inner carrier 21 and a second outer decorative cover 22 provided with at least one second locking member 221 on an inner side of the second outer decorative cover 22. The second inner carrier 21 is composed of a second chamber 211 on an inner side thereof, a second recess 212 on an outer side thereof, and at least one second mounting slot 213 and at least one second locking slot 214 disposed on two sides of the second recess 212 correspondingly. The second mounting slot 213 corresponds to the first mounting slot 113 and is used for mounting the second magnetic member 5 therein. The first magnetic member 4 and the second magnetic member 5 are magnetically attached to each other while the second locking slot 214 and the second locking member 221 corresponding to the second locking slot 214 are mounted and positioned by each other so that the second outer decorative cover 22 is disposed on the second recess 212 of the second inner carrier 21 and covering the second recess 212.

The sprayer 3 is mounted in the first chamber 111 of the first housing 1 and the second chamber 211 of the second housing 2 correspondingly.

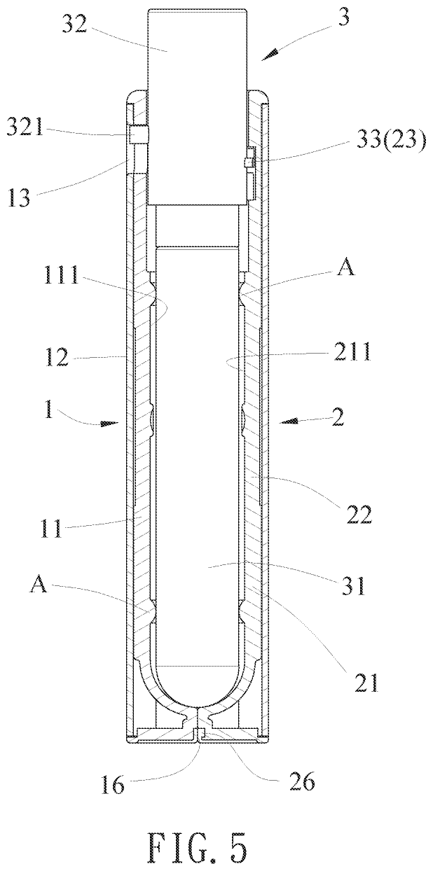

Refer to FIG. 1 and FIG. 5, by the first and the second housings 1, 2 able to be split in halves and the magnetic members 4, 5 hidden inside the first and the second housings 1, 2, the sprayer 3 can be mounted and positioned in the first and the second chambers 111, 211 quickly and easily due to magnetic attraction. Disassembly of the present container for replacement of the sprayer 3 is also easy to operate. Moreover, the first recess 112 formed on an outer side of the first inner carrier 11 makes the first inner carrier 11 to have design of a frame. When the first inner carrier 11 and the first outer decorative cover 12 are made of different materials or having different patterns, colors or surface treatment, there are clear and beautiful lines formed at a junction therebetween. The second inner carrier 21 and the second outer decorative cover 22 also have the same feature. When the first and the second housings 1, 2 are magnetically attached to each other, the two frames attached highlight a sense of design of the first and the second outer decorative covers 12, 22 and the container has diverse styles. After magnetic attraction of the first and the second housings 1, 2, the style of the container can be a cylinder, a polygonal column, etc. Thereby both texture and practicability of the container are improved.

By the arrangement of the respective components mentioned above, the first and the second housings 1, 2 are magnetically attached to each other to form a container for mounting the sprayer 3. Please refer to the following embodiments to learn more details and applications of the present container.

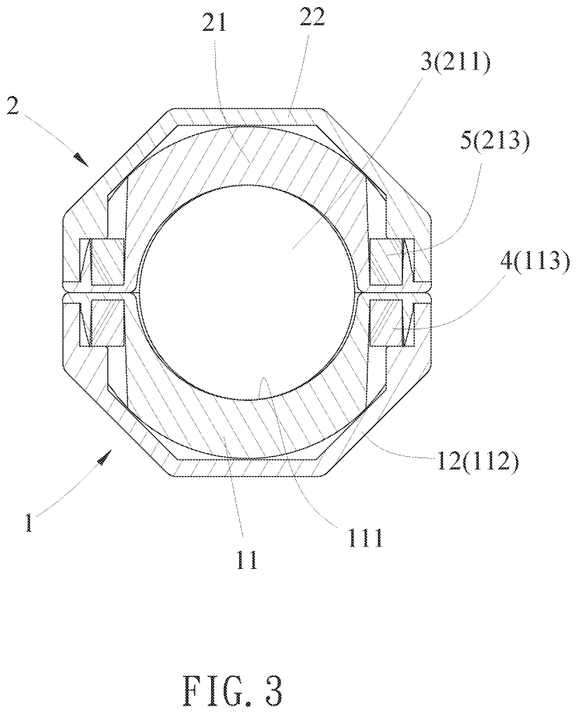

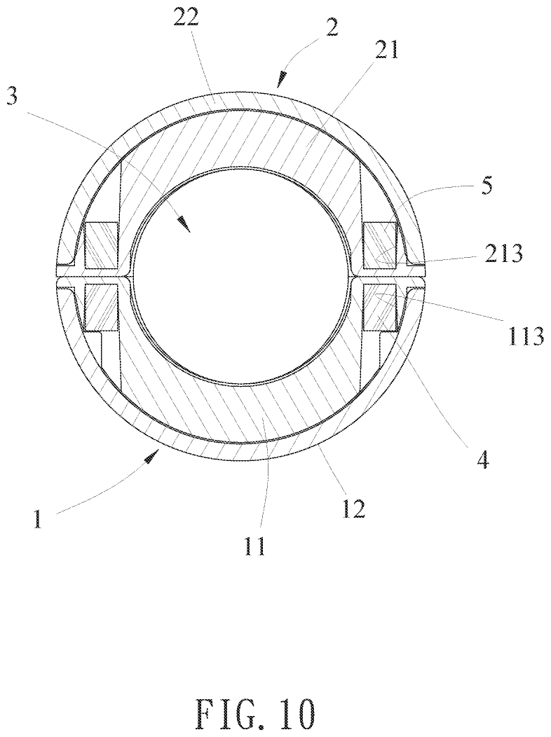

Please refer to FIG. 1-13, the sprayer 3 of the present invention can be applied to different kinds of spray products with liquid therein such as fragrance or cosmetics. The sprayer 3 mainly consists of a bottle 31, a press head 32 and a nozzle located on the press head 32. The sprayer 3 has different designs with respect to the two housings 1, 2.

First, the bottle 31 of the spray 3 has different curve designs. An inner surface of both the first chamber 111 of the first inner carrier 11 and the second chamber 211 of the second inner carrier 21 is provided with a plurality of positioning portions A corresponding to the bottle 31 of the sprayer 3 and used to limit the sprayer 3. Thus the sprayer 3 is positioned well inside the first and the second chambers 111, 211, located at a central position and unable to wobble easily. Moreover, the sprayers 3 have different lengths.

Embodiment one: refer to FIG. 1-7, the press head 32 of the sprayer 3 is exposed and protruding from an upper end of the first and the second housings 1, 2 (as shown in FIG. 2). A protruding long nozzle 321 is disposed on the press head 32 of the sprayer 3 while a slot 13 is arranged at the first housing 1 and corresponds to the long nozzle 321 for allowing the long nozzle 321 to move therein. When users press the press head 32, the long nozzle 321 is moved vertically inside the slot 13 along with user's pressing. The slot 13 consists of a pressing segment 131 and a locking segment 132 which are respectively allowing the long nozzle 321 to move vertically and horizontally. The locking segment 132 is extending horizontally from a top end of the pressing segment 131. By rotating the sprayer 3, the long nozzle 321 is moved horizontally in the locking segment 132 of the slot 13 and locked while being away from the pressing segment 131 and now the press head 32 is unable to be pressed. When the sprayer 3 is rotated in a reverse direction, the long nozzle 321 is moved horizontally to the top end of the pressing segment 131 to be in a released state during which the press head 32 is able to be pressed. The above design prevents liquid in the sprayer 3 from being sprayed out when the sprayer 3 is not in use and users accidentally touch or press the press head 32 on top end of the container.

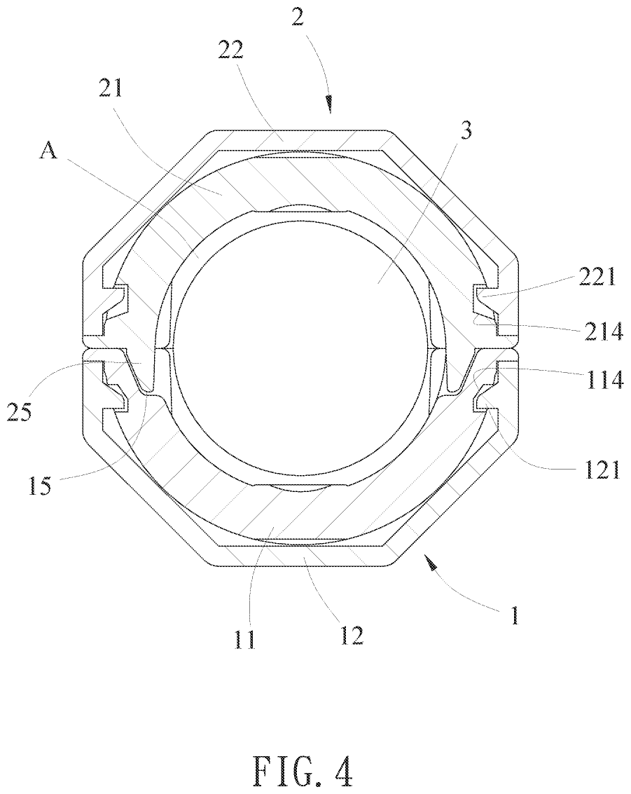

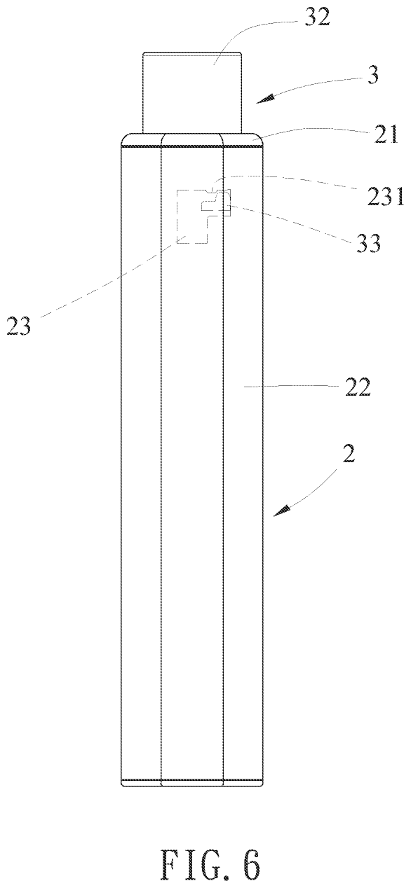

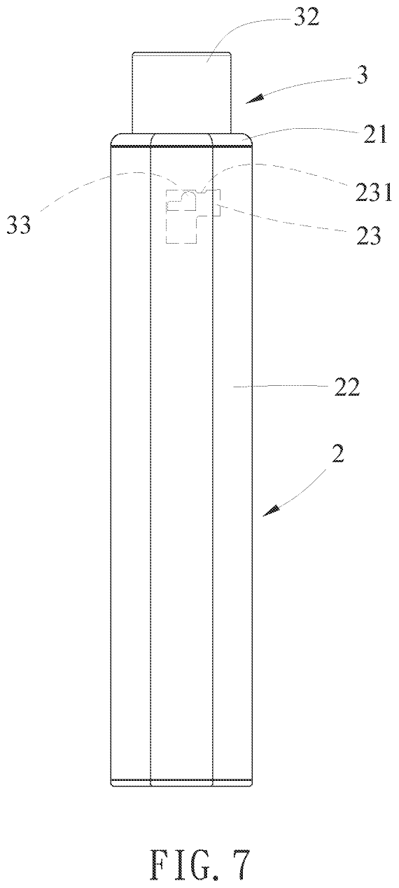

Furthermore, in order to ensure that the sprayer 3 will not be rotated freely while being locked or in the released state, a braking block 33 is disposed on a position opposite to the long nozzle 321 of the press head 32 while a locking recess 23 is arranged at the second housing 2 and corresponds to the braking block 33, as shown in FIG. 1 and FIG. 4. The locking recess 23 allows the braking block 33 to move therein and is provided with a bump 231 for limiting movement of the braking block 33. When the long nozzle 321 of the sprayer 3 is rotated to be in a locked state, the braking block 33 is limited by the bump 231 which creates resistance for preventing the sprayer 3 from rotating freely. When rotating force is larger than the resistance, the braking block 33 on the press head 32 is moved across the bump 23 to be released, as shown in FIG. 6 and FIG. 7.

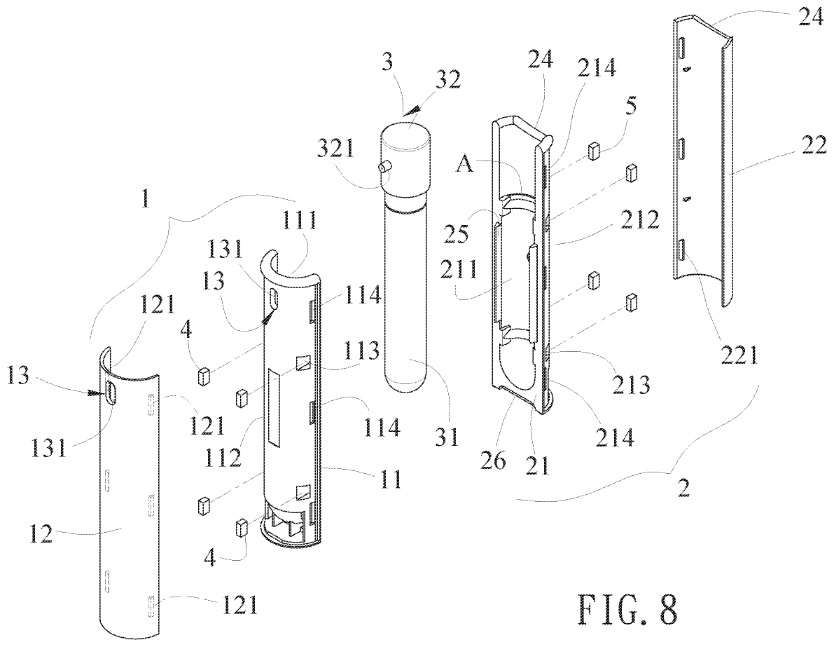

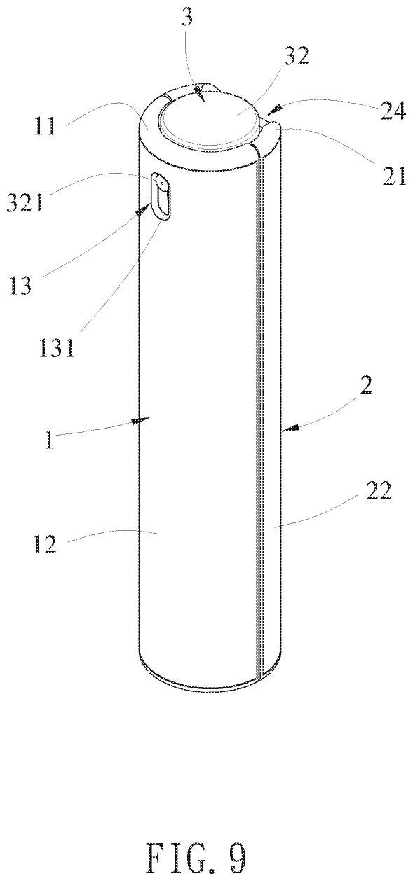

Embodiment two: refer to FIG. 8-11, the press head 32 of the sprayer 3 is located inside the first and the second housings 1, 2 without protruding outside (as shown in FIG. 9). In this embodiment, an action groove 24 is disposed on an upper surface of the second housing 2 as a space for allowing the press head 32 of the sprayer 3 to be pressed and moved therein. A slot 13 is arranged at the first housing 1 and corresponds to the long nozzle 321. The slot 13 includes a pressing segment 131 arranged vertically for allowing the long nozzle 321 to move vertically therein. Thereby the long nozzle 321 is moved upward and downward in the slot 13 along with the pressing when the user presses the press head 32. In this embodiment, the magnetic attraction between the first and the second housings 1, 2 is the same as the above embodiment.

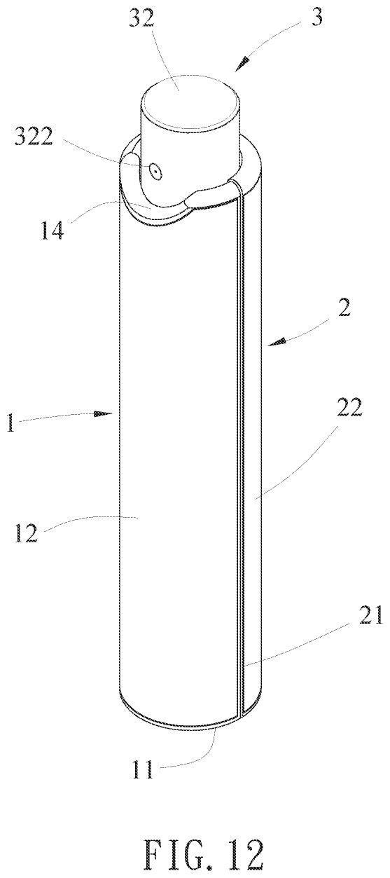

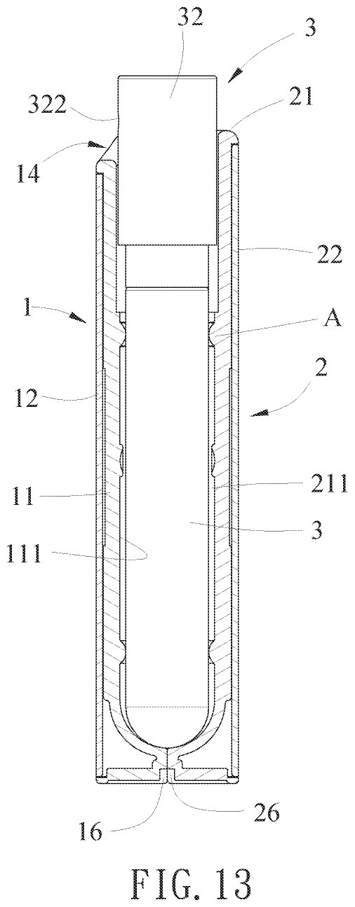

Embodiment three: refer to FIG. 12 and FIG. 13, the press head 32 of the sprayer 3 is provided with a planar nozzle 322 while a spray slot 14 is mounted to the first housing 1 and corresponds to a space for allowing the planar nozzle 322 to be pressed and moved. The spray slot 14 provides a moveable space for vertical movement of the planar nozzle 322 when the press head 32 of the sprayer 3 is pressed.

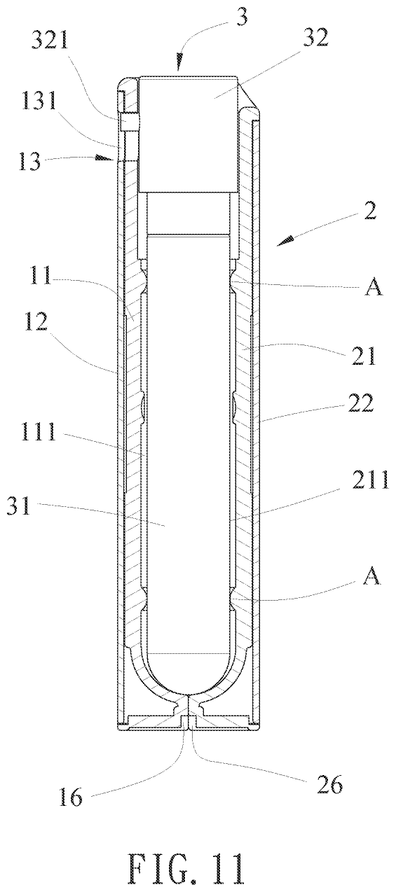

In order to make the magnetic attraction between the first housing 1 and the second housing 2 become more stable, please refer to FIG. 1, FIG. 4-5, FIG. 8 and FIG. 11, a recessed portion 15 is disposed on an inner side of the first housing 1 while a protruding portion 25 is arranged at an inner side of the second housing 2 and corresponds to the recessed portion 15. The protruding portion 25 is mounted into the recessed portion 15 correspondingly for assistance in the magnetic attraction and positioning (as shown in FIG. 4). Moreover, when the user intends to separate the first housing 1 and the second housing 2 to take out the sprayer 3 inside the first and the second chambers 111, 211, a first-half slot 16 is disposed on a bottom of the first housing 1 while a second-half slot 26 is arranged at a bottom of the second housing 2 and corresponds to the first-half slot 16. Thereby the first-half slot 16 and the second-half slot 26 are where the user applies a force to separate the first housing 1 and the second housing 2 easily and conveniently (as shown in FIG. 5 and FIG. 11).

In summary, the container according to the present invention has the following advantages.

1. By the two housings easy to be split in halves and the magnetic members hidden inside the two housings, the sprayer can be mounted and positioned magnetically in the chambers quickly and conveniently. The container is easy to be disassembled for replacement of the sprayer.

2. The two housings are connected by magnetic attraction of the magnetic members. The inner carrier sand the outer decorative covers are made of different materials or having different patterns, colors or surface treatment so that the container has diverse styles and both texture and practicability of the container are improved.

3. By the inverted L-shaped slot composed of the pressing segment and the locking segment in combination with the bump of the locking recess, liquid in the sprayer will not be sprayed out when the sprayer is not in use and users accidentally touch or press the press head protruding from the top end of the container.

4. The sprayer can be replaced conveniently by easy disassembly of the magnetically-attached housings. This is based on a concept of refill packs and such design meets requirements for environmental protection and convenience while travelling.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A container comprising:
a first housing which includes a first inner carrier and a first outer decorative cover; the first inner carrier having a first chamber on an inner side thereof, a first recess on an outer side thereof, and at least one first mounting slot and at least one first locking slot arranged at two sides of the first recess correspondingly; the first mounting slot is used to mount a first magnetic member therein while at least one first locking member is disposed on an inner side of the first outer decorative cover and corresponds to the first locking slot; the first locking member and the first locking slot are mounted and positioned by each other so that the first outer decorative cover is disposed on the first recess of the first inner carrier and covering the first recess;
a second housing which includes a second inner carrier and a second outer decorative cover; the second inner carrier having a second chamber on an inner side thereof, a second recess on an outer side thereof, and at least one second mounting slot and at least one second locking slot disposed on two sides of the second recess correspondingly; the second mounting slot corresponds to the first mounting slot and is used for mounting a second magnetic member therein while the first magnetic member and the second magnetic member have magnetic attraction therebetween; at least one second locking member is disposed on an inner side of the second outer decorative cover and corresponds to the second locking slot; the second locking member and the second locking slot are mounted and positioned by each other so that the second outer decorative cover is disposed on the second recess of the second inner carrier and covering the second recess; and a sprayer which is mounted in the first chamber of the first housing and the second chamber of the second housing correspondingly.

2. The container as claimed in claim 1, wherein a recessed portion is disposed on an inner side of the first housing while a protruding portion is arranged at an inner side of the second housing and corresponds to the recessed portion; the protruding portion is mounted into the recessed portion correspondingly for assistance in the magnetic attraction.

3. The container as claimed in claim 1, wherein a first-half slot is disposed on a bottom of the first housing and a second-half slot is arranged at a bottom of the second housing while the first-half slot and the second-half slot are disposed corresponding to the each other.

4. The container as claimed in claim 2, wherein a first-half slot is disposed on a bottom of the first housing and a second-half slot is arranged at a bottom of the second housing while the first-half slot and the second-half slot are disposed corresponding to the each other.

5. The container as claimed in claim 1, wherein the sprayer includes a bottle, a press head, and a long nozzle protruding from the press head; a slot is arranged at the first housing and corresponds to the long nozzle; the slot is provided with a pressing segment for allowing the long nozzle to move vertically therein.

6. The container as claimed in claim 2, wherein the sprayer includes a bottle, a press head, and a long nozzle protruding from the press head; a slot is arranged at the first housing and corresponds to the long nozzle; the slot is provided with a pressing segment for allowing the long nozzle to move vertically therein.

7. The container as claimed in claim 5, wherein the slot further includes a locking segment which is extending horizontally from a top end of the pressing segment and used for allowing the long nozzle to move horizontally therein.

8. The container as claimed in claim 6, wherein the slot further includes a locking segment which is extending horizontally from a top end of the pressing segment and used for allowing the long nozzle to move horizontally therein.

9. The container as claimed in claim 7, wherein a braking block is disposed opposite to the long nozzle of the press head while a locking recess is arranged at the second housing and corresponds to the braking block; the locking recess allows the braking block to move therein and is provided with a bump for limiting movement of the braking block.

10. The container as claimed in claim 8, wherein a braking block is disposed opposite to the long nozzle of the press head while a locking recess is arranged at the second housing and corresponds to the braking block; the locking recess allows the braking block to move therein and is provided with a bump for limiting movement of the braking block.

11. The container as claimed in claim 1, wherein an action groove is disposed on an upper surface of the second housing as a space for allowing the press head of the sprayer to be pressed and moved therein.

12. The container as claimed in claim 2, wherein an action groove is disposed on an upper surface of the second housing as a space for allowing the press head of the sprayer to be pressed and moved therein.

13. The container as claimed in claim 1, wherein the sprayer includes a bottle, a press head, and a planar nozzle located at the press head; a spray slot is mounted to the first housing and corresponds to a space for allowing the planar nozzle to be pressed and moved therein.

14. The container as claimed in claim 2, wherein the sprayer includes a bottle, a press head, and a planar nozzle located at the press head; a spray slot is mounted to the first housing and corresponds to a space for allowing the planar nozzle to be pressed and moved therein.

15. The container as claimed in claim 1, wherein an inner surface of both the first chamber of the first inner carrier and the second chamber of the second inner carrier is provided with a plurality of positioning portions corresponding to the sprayer and used to limit the sprayer.

16. The container as claimed in claim 2, wherein an inner surface of both the first chamber of the first inner carrier and the second chamber of the second inner carrier is provided with a plurality of positioning portions corresponding to the sprayer and used to limit the sprayer.
